(19) United States
(12) Patent Application Publication
(10) Pub. No.: US 2019/0249727 A1
(43) Pub. Date: Aug. 15, 2019

(54) CONTROLLER, CONTROL METHOD, AND CLUTCH CONTROLLER

(71) Applicant: DENSO TEN Limited, Kobe-shi (JP)

(72) Inventor: Ryosuke KUROKAWA, Kobe-shi (JP)

(73) Assignee: DENSO TEN Limited, Kobe-shi (JP)

(21) Appl. No.: 16/267,661

(22) Filed: Feb. 5, 2019

(30) Foreign Application Priority Data
Feb. 15, 2018 (JP) 2018-025305

(51) Int. Cl. F16D 48/06; B60W 10/02; F16H 61/14

(52) U.S. Cl. CPC F16D 48/06; F16H 61/143; B60W 10/02

(57) ABSTRACT

A controller according to an embodiment that controls a control object by driving a motor includes an estimation unit and a switching unit. The estimation unit estimates a load of the control object on the basis of a value of a current applied to the motor. The switching unit switches control contents between learning control in which learning is performed on the basis of the load estimation and normal control other than the learning control. The control contents in the learning control cause the current fluctuation in the learning control to be further reduced than that in the normal control using other control contents.

### CROSS-REFERENCE TO RELATED APPLICATION

This application is based upon and claims the benefit of priority of the prior Japanese Patent Application No. 2018-025305, filed on Feb. 15, 2018, the entire contents of which are incorporated herein by reference.

### FIELD

A disclosed embodiment relate to a controller, a control method, and a clutch controller.

### BACKGROUND

Techniques have been known that control transmission amounts by rotation angles of motors in drive systems in which drive force is transmitted using clutches or hydraulic pressure, for example. For example, in a transmission system using a clutch, a transmission amount depends on an amount of engagement of the clutch or an amount of disengagement of the clutch. The amount is controlled by a rotation angle of a motor that causes the clutch to be engaged. Feedback control is used as the method for controlling the rotation angle, for example.

In such feedback control, a compensation amount is learned in some cases for compensating a variation occurring due to individual differences and aging of clutches serving as control objects and components such as motors. For example, refer to Japanese Laid-open Patent Publication No. 11-108167. In such learning, a torque curve is estimated that indicates a value of a current practically needed to be applied to a motor with respect to a target rotation angle of the motor, for example. The compensation amount is learned on the basis of estimation of a load of the control object.

The conventional technique, however, has room for further improvement to increase an accuracy of estimation of the load of the control object.

The clutch has a hysteresis width between motor torque needed in clutch engagement operation and motor torque needed in clutch disengagement operation because the clutch includes mechanical elements having elasticity such as a diaphragm spring. As a result, a current applied to the motor is controlled by a value in the hysteresis width. This control causes a value of the current to easily change up and down. As a result, an error is superimposed on the torque curve in some cases.

In order to reduce the up-down change in the current value, a method may be employed in which a pulse width modulation (PWM) frequency is increased to high frequency. The method, however, has a disadvantage of increase in emission noise and processing load.

### SUMMARY

A controller according to an embodiment that controls a control object by driving a motor includes an estimation unit and a switching unit. The estimation unit estimates a load of the control object on the basis of a value of a current applied to the motor. The switching unit switches control contents between learning control in which learning is performed on the basis of the load estimation and normal control other than the learning control. The control contents in the learning control cause the current fluctuation in the learning control to be further reduced than that in the normal control using other control contents.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1A is a first schematic explanatory view of a control method according to an embodiment.

FIG. 1B is a second schematic explanatory view of the control method in the embodiment.

FIG. 1C is a third schematic explanatory view of the control method in the embodiment.

FIG. 1D is a fourth schematic explanatory view of the control method in the embodiment.

FIG. 2 is a block diagram of a control system in the embodiment.

FIG. 3 is a diagram illustrating differences in control contents between normal control and learning control.

FIG. 4 is a flowchart illustrating a procedure of processing performed by a controller in the embodiment.

### DESCRIPTION OF EMBODIMENT

The following describes an embodiment of a controller, a control method, and a clutch controller disclosed by the invention in detail with reference to the accompanying drawings. The following embodiment does not limit the invention.

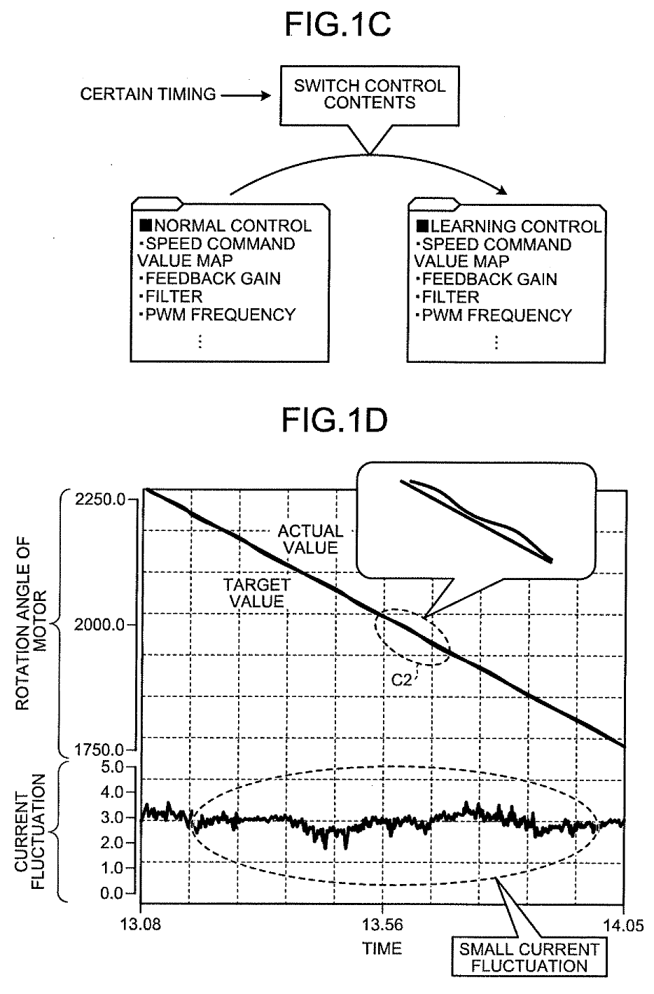

In the following description, a clutch in a drive system such as a vehicle is a control object, and a controller 10 (refer to FIG. 2) is an example that controls engagement operation and disengagement operation of the clutch by a rotation angle of a motor M (refer to FIG. 2).

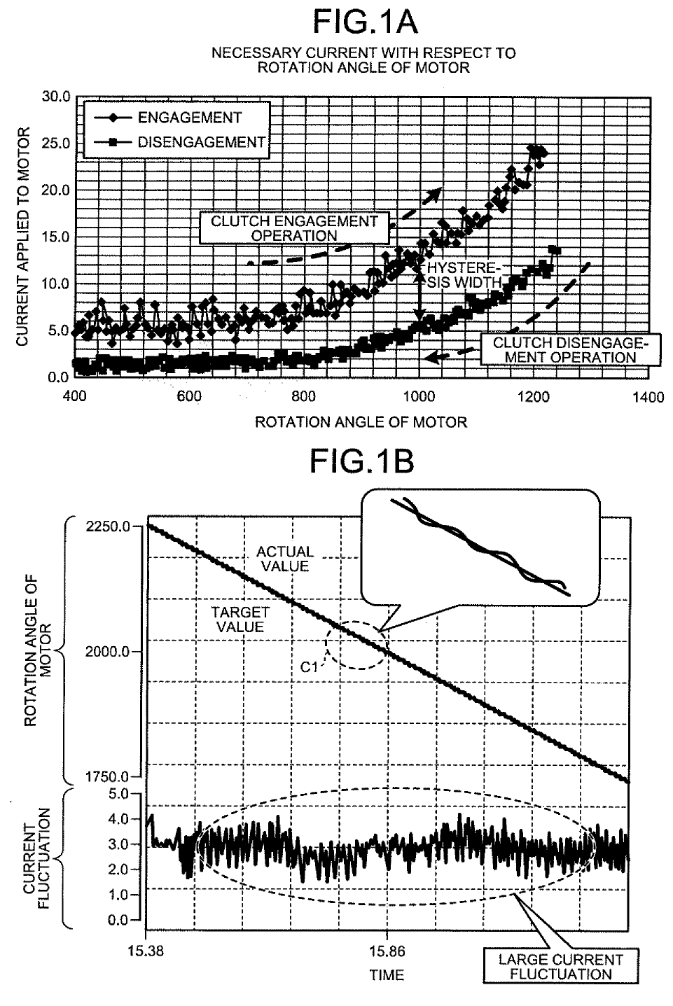

An outline of the control method according to the embodiment is described with reference to FIGS. 1A to 1D. FIGS. 1A to 1D are first to fourth schematic explanatory views of the control method in the embodiment.

FIG. 1A illustrates an example of a needed current with respect to a rotation angle of the motor. As illustrated in FIG. 1A, a current needed to be applied to the motor M has a hysteresis width between “clutch engagement operation” and “clutch disengagement operation” due to the clutch structure.

When the controller 10 is in normal control, the rotation angle of the motor M is controlled to any value in the hysteresis width. This control causes a current value to easily change up and down as prominently observed in the “clutch engagement operation” in FIG. 1A, for example. The up-down change in the current value, which is smaller than that in the “clutch engagement operation”, is also observed in the “clutch disengagement operation”.

When a torque curve is learned in such a state where the current value easily changes up and down, an actual value of the rotation angle of the motor repeatedly crosses the target value of the rotation angle of the motor (refer to region C1 in FIG. 1B) in feedback control, as illustrated in FIG. 1B. The motor M repeats normal rotation and reverse rotation, causing a large current fluctuation. As a result, an error is easily superimposed on the torque curve.

The control method in the embodiment provides learning control in which the torque curve is learned besides the normal control by the controller 10. Between the normal control and the learning control, control contents are switched. The control contents are switched such that the current fluctuation in the learning control is further reduced than that in the normal control.

Specifically, as illustrated in FIG. 1C, in the control method in the embodiment, the normal control proceeds, at a “certain timing”, to the learning control in which the torque curve is learned, and the control contents are switched from those in the normal control to those in the learning control.

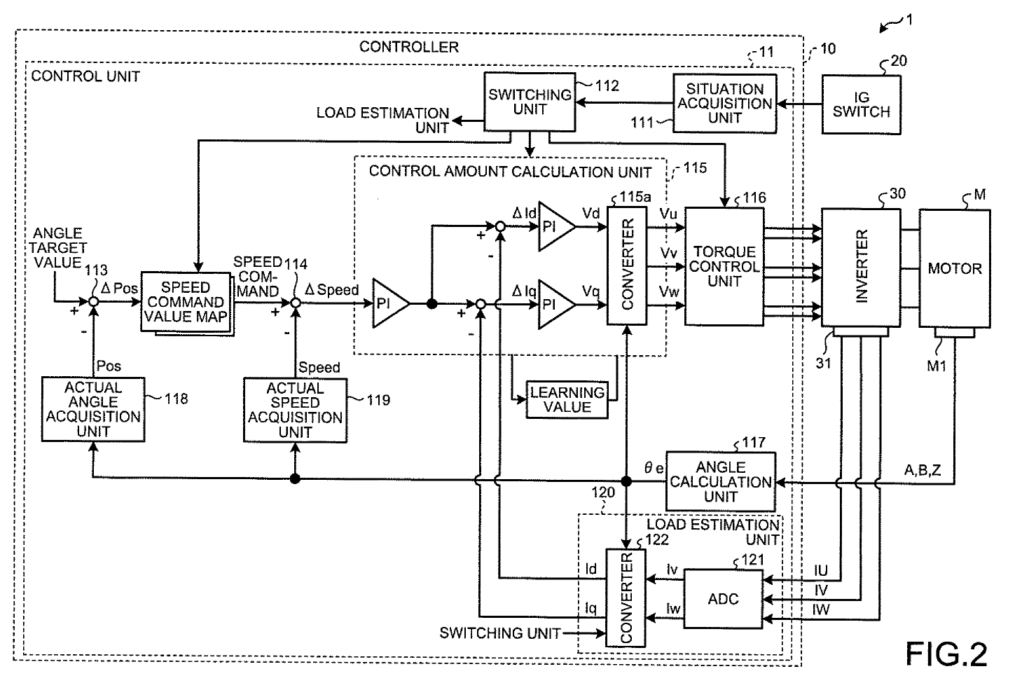

The control contents include a “speed command value map”, a “feedback gain”, a “filter”, and a “pulse width modulation (PWM) frequency”. In the control method in the embodiment, the control contents are switched such that the current fluctuation is reduced in the “learning control”. Specific examples of the control contents are described later with reference to FIG. 3. In the control method in the embodiment, the torque curve is learned in the learning control mainly in the “clutch disengagement operation”, in which the current fluctuation is relatively small as illustrated in FIG. 1A.

For example, in the control method in the embodiment, as illustrated in FIG. 1D, the torque curve is developed such that the target value of the rotation angle of the motor is gradually reduced along the time axis while following the “clutch disengagement operation” and the actual value follows the target value but not cross the target value (refer to region C2 in FIG. 1D). The motor M, thus, does not repeat the normal rotation and the reverse rotation, resulting in the current fluctuation being reduced, thereby making it difficult for an error to be superimposed on the torque curve.

At the certain timing, other systems are hardly influenced by an emission noise when the PWM frequency is changed, for example, and the normal control can be stopped. The certain timing in a vehicle is a timing at which the vehicle is stopped and other systems do not operate, for example. For example, the certain timing is in a certain time period after an ignition switch (hereinafter described as the “IG switch”) is turned off.

As described above, in the control method using the controller 10 that controls the control object by driving the motor M in the embodiment, the load of the control object is estimated by the value of the current applied to the motor M, and the control contents are switched between the learning control in which the learning is performed on the basis of the load estimation and the normal control other than the learning control. The control contents are switched such that the current fluctuation in the learning control is smaller than that in the normal control. The timing at which the normal control is switched to the learning control is the certain timing at which the other systems are hardly influenced.

The control method in the embodiment, thus, can increase accuracy of estimation of the load of the control object. The following more specifically describes a control system 1 that includes the controller 10 to which the control method described above is applied and is mounted on a vehicle.

FIG. 2 is a block diagram of the control system 1 in the embodiment. In FIG. 2, only components needed to explain the feature of the embodiment are illustrated by functional blocks and common components are omitted.

In other words, the respective components illustrated in FIG. 2 are functionally conceptual and need not to be physically structured as illustrated. For example, the specific mode of distribution and integration of the respective functional blocks are not limited to that illustrated in FIG. 2. The whole or a part of the functional blocks can be structured by being functionally or physically distributed or integrated on the basis of any unit in accordance with the various loads and usage conditions.

As illustrated in FIG. 2, the control system 1 includes the controller 10, an IG switch 20, an inverter 30, and the motor M. The IG switch 20 is a start switch of the vehicle.

The inverter 30, which is a three-phase output inverter, for example, drives the motor M under the control of the controller 10. The inverter 30 includes a current sensor 31. The current sensor 31, which is a shunt resistance, for example, detects three-phase current values IU, IV, and IW that are applied to the motor M and outputs the detected values to the controller 10.

The motor M, which is a three-phase alternating current motor, for example, controls an amount of engagement or disengagement of a clutch, which is not illustrated, on the basis of its rotation angle. The motor M includes an angular sensor M1. The angular sensor M1 detects a rotation angle of the motor M and outputs angular sensor signals A, B, and Z to the controller 10.

The controller 10 includes a control unit 11. The control unit 11 includes a situation acquisition unit 111, a switching unit 112, subtractors 113 and 114, a control amount calculation unit 115, a torque control unit 116, an angle calculation unit 117, an actual angle acquisition unit 118, an actual speed acquisition unit 119, and a load estimation unit 120. The control amount calculation unit 115 includes a converter 115a. The load estimation unit 120 includes an analog digital converter (ADC) 121 and a converter 122.

The control unit 11, which is a controller, for example, includes a micro controller, an application specific integrated circuit (ASIC), a field programmable gate array (FPGA), and a central processing unit (CPU), for example. The control unit 11 controls the whole of the controller 10.

The situation acquisition unit 111 acquires a situation of the vehicle. The situation acquisition unit 111 acquires a situation of the IG switch 20 as the situation of the vehicle, for example. The situation acquisition unit 111 notifies the switching unit 112 of the acquired situation of the vehicle.

The switching unit 112 switches the normal control and the learning control on the basis of the situation of the vehicle notified from the situation acquisition unit 111. When receiving the notification that the IG switch 20 is turned off, for example, from the situation acquisition unit 111, the switching unit 112 switches the control contents of the control unit 11 from those in the normal control to those in the learning control, thereby causing the controller 10 to proceed to what is called a learning control mode.

In the switching, the switching unit 112 switches at least the speed command value map, the feedback gain, the filer, and the PWM frequency from those in the normal control to those in the learning control. The switching unit 112 instructs the control amount calculation unit 115 to switch the feedback gain. The switching unit 112 instructs the load estimation unit 120 to switch the filter. The switching unit 112 instructs the torque control unit 116 to switch the PWM frequency.

The following describes differences in control contents between the normal control and the learning control with reference to FIG. 3. FIG. 3 is a diagram illustrating differences in control contents between the normal control and the learning control. The speed command value map associates an angle deviation ΔPos output from the subtractor 113, which is described later, with a speed command value. As illustrated in FIG. 3, the speed command value map is switched such that the speed in the “learning control” is relatively “lower” than that in the “normal control.”

The feedback gain is used by the control amount calculation unit 115, which is described later. The feedback gain is switched such that the feedback gain in the “learning control” is relatively “lower” than that in the “normal control”. The filter is used by the load estimation unit 120, which is described later. The filter, which is a low-pass filter, for example, is switched such that averaging in the “learning control” is relatively heavier than that in the “normal control”.

The PWM frequency is used by the torque control unit 116, which is described later. The PWM frequency is switched such that the PWM frequency in the “learning control” is relatively “higher” than that in the “normal control.” Those respective control contents are switched such that the current fluctuation in the “learning control” is smaller than that in the “normal control”. In other words, the control parameters switched from those in the normal control cause the current fluctuation in the learning control to be further reduced than that in the normal control. For example, the PWM frequency in the “normal control” is 10 kHz and the current fluctuation width corresponding to the PWM frequency is 4 A. When the PWM frequency in the “learning control” is 20 kHz after the switching, the current fluctuation width can be reduced to 2 A.

Referring back to FIG. 2, the subtractor 113 is described. The subtractor 113 subtracts an actual angle Pos of the motor M, the actual angle Pos being output from the actual angle acquisition unit 118, from an angle target value, and outputs the resulting angle deviation ΔPos. The angle deviation ΔPos is converted into the speed command by the speed command value map. When the control mode proceeds to the learning control mode, the speed command value map is switched by the switching unit 112 to that in the learning control.

The subtractor 114 subtracts an actual speed Speed of the motor M, the actual speed Speed being output from the actual speed acquisition unit 119, from the speed command, and outputs the resulting speed deviation ΔSpeed.

The control amount calculation unit 115 performs a proportional integration (PI) computing on the speed deviation ΔSpeed output from the subtractor 114 on the basis of a certain feedback gain. The control amount calculation unit 115 subtracts a d-axis current value Id from the speed deviation ΔSpeed after PI to obtain a d-axis current value deviation ΔId while the control amount calculation unit 115 subtracts a q-axis current value Iq from the speed deviation ΔSpeed after PI to obtain a q-axis current value deviation ΔIq. The d-axis current value Id and the q-axis current value Iq are output from the load estimation unit 120, which is described later.

The control amount calculation unit 115 performs the PI computation on the obtained d-axis current value deviation ΔId and q-axis current value deviation ΔIq on the basis of a certain feedback gain to obtain a d-axis voltage command value Vd and a q-axis voltage command value Vq, respectively.

The control amount calculation unit 115 performs, by the converter 115a, coordinate conversion from two-phase to three-phase using a rotation angle θe of the motor M to convert the d-axis voltage command value Vd and the q-axis voltage command value Vq into a U-phase voltage command value Vu, a V-phase voltage command value Vv, and a W-phase voltage command value Vw. The control amount calculation unit 115 outputs the respective phase voltage command values Vu, Vv, and Vw to the torque control unit 116. In the learning control, the control amount calculation unit 115 switches the feedback gain from that in the normal control to that in the learning control on the basis of the instruction from the switching unit 112.

In the learning control, the control amount calculation unit 115 performs learning on the torque curve using the d-axis current value Id and the q-axis current value Iq, which are output from the load estimation unit 120, to update a learning value serving as a compensation amount for compensating variation. In the normal control, the control amount calculation unit 115 compensates a control amount using the learning value in the calculation.

The torque control unit 116 performs pulse width modulation on the respective phase voltage command values Vu, Vv, and Vw output from the control amount calculation unit 115 on the basis of a certain PWM frequency to produce PWM signals serving as a voltage command that controls the inverter 30. The torque control unit 116 outputs the produced PWM signals to the inverter 30. In the learning control, the torque control unit 116 switches the PWM frequency from that in the normal control to that in the learning control on the basis of the instruction from the switching unit 112.

The angle calculation unit 117 calculates the rotation angle θe on the basis of the angular sensor signals A, B, and Z output from the angular sensor M1, and outputs the rotation angle θe to the converter 115a, the actual angle acquisition unit 118, the actual speed acquisition unit 119, and a converter 122.

The actual angle acquisition unit 118 acquires the actual angle Pos on the basis of the rotation angle θe output from the angle calculation unit 117. The actual speed acquisition unit 119 acquires the actual speed Speed on the basis of the rotation angle θe output from the angle calculation unit 117.

The load estimation unit 120 estimates the load of the control object on the basis of the three-phase current values IU, IV, and IW that are output from the current sensor 31. Specifically, the ADC 121 performs analog-digital conversion on the three-phase current values IU, IV, and IW to output a V-phase current value Iv and a W-phase current value Iw.

The converter 122 performs coordinate conversion from three-phase to two-phase using the rotation angle θe, i.e., converts the V-phase current value Iv and the W-phase current value Iw into the d-axis current value Id and the q-axis current value Iq, respectively, and outputs the d-axis current value Id and the q-axis current value Iq to the control amount calculation unit 115. The load estimation unit 120 is provided with a certain filter, which is omitted to be illustrated. The converter 122 outputs the d-axis current value Id and the q-axis current value Iq while averaging the V-phase current value Iv and the W-phase current value Iw that are output from the ADC 121 using the certain filter, for example. The load estimation unit 120 switches the filter from that in the normal control to that in the learning control on the basis of the instruction from the switching unit 112 in the learning control.

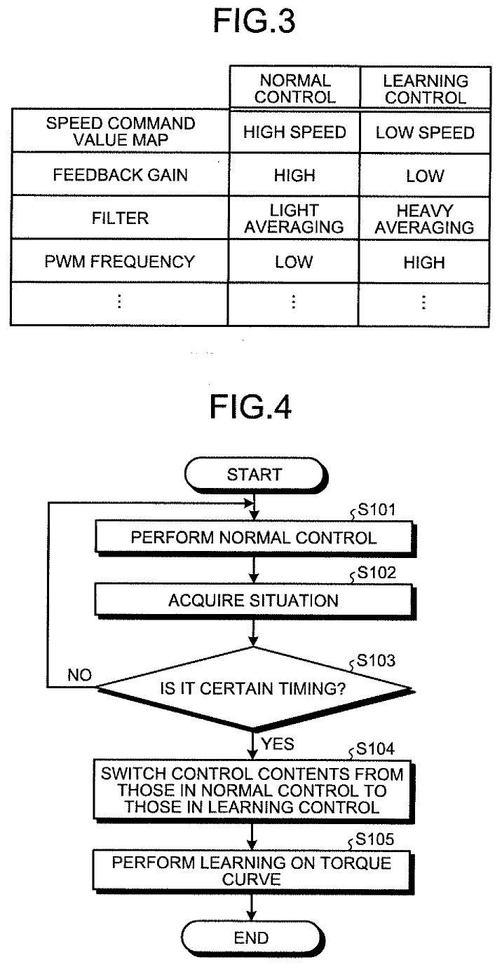

The following describes a procedure of the processing performed by the controller 10 in the embodiment with reference to FIG. 4. FIG. 4 is a flowchart illustrating the procedure of the processing performed by the controller 10 in the embodiment.

The control unit 11 performs the normal control after the IG switch 20 is turned on and the vehicle is energized, for example (step S101). The situation acquisition unit 111 acquires the situation of the vehicle (step S102).

The switching unit 112 determines whether it is certain timing to proceed to the learning control mode on the basis of the situation acquired by the situation acquisition unit 111 (step S103). If it is the certain timing (Yes at step S103), the switching unit 112 switches the control contents from those in the normal control to those in the learning control (step S104). If it is not the certain timing (No at step S103), the processing from step S101 to step S103 is repeated.

After the control contents are switched to those in the learning control, the control unit 11 performs learning on the torque curve (step S105), and thereafter ends the processing.

As described above, in the embodiment, the controller 10 that controls the control object by driving the motor M includes the load estimation unit 120, which corresponds to an example of the “estimation unit”, and the switching unit 112. The load estimation unit 120 estimates the load of the control object on the basis of the values of currents applied to the motor M. The switching unit 112 switches the control contents between the learning control in which learning is performed on the basis of the load estimation and the normal control other than the learning control. The control contents in the learning control cause the current fluctuation in the learning control to be further reduced than that in the normal control using other control contents.

The controller 10 in the embodiment, thus, can increase accuracy of estimation of the load of the control object.

The switching unit 112 switches the control contents from those in the normal control to those in the learning control only at certain timing. The controller 10 in the embodiment performs learning on the torque curve only at timing at which other systems are hardly influenced by an emission noise, for example, when the PWM frequency is changed, for example. The controller 10 can cause an error to be hardly superimposed on the torque curve. The controller 10, thus, can increase accuracy of estimation of the load of the controlled object.

The switching unit 112 stops the normal control at the certain timing. The controller 10 in the embodiment stops the normal control in the learning control, thereby making it possible to reduce an influence caused by an increase in processing load. The controller 10, thus, can increase accuracy of estimation of the load of the controlled object.

The control object is controlled on the basis of feedback control performed on the motor M. The switching unit 112 switches at least one of the speed command value map corresponding to the actual rotation angle of the motor M, the feedback gain, the filter, and the PWM frequency in the control contents. The controller 10 in the embodiment, thus, can increase accuracy of estimation of the load of the control object in the learning control under the feedback control.

The control object and the motor M are mounted on the vehicle. The switching unit 112 performs switching at timing when the IG switch 20 of the vehicle is turned off, the timing being the certain timing. In the controller 10 in the embodiment, the learning control is in the timing at which the vehicle is stopped and other systems do not operate, and thus, the other systems are not influenced by an emission error, for example, even when the PWM frequency is changed. The controller 10, thus, can increase accuracy of estimation of the load of the control object.

In the embodiment, the controller 10, which corresponds to an example of the “clutch controller”, includes the load estimation unit 120 and the switching unit 112. The load estimation unit 120 estimates a load in clutch control on the basis of the values of currents applied to the motor M. The switching unit 112 switches control contents in the clutch engagement operation or the clutch disengagement operation between the learning control in which the learning is performed on the basis of the load estimation and the normal control other than the learning control. The control contents in the learning control cause the current fluctuation in the learning control to be further reduced than that in the normal control using other control contents. The controller 10 in the embodiment, thus, can increase accuracy of estimation of the load of the clutch.

In the embodiment, the learning is performed on the torque curve in the clutch disengagement operation (refer to FIG. 1D). The learning may be performed on the torque curve in the clutch engagement operation. In this case, the learning is performed on the torque curve in which the actual value follows the target value under the target value and does not exceed the target value.

In the embodiment, the hysteresis width is present. The embodiment, of course, can be applied to a case where no hysteresis width is present due to the structure of the control object.

In the embodiment, the control object is the clutch. The control object is not limited to any specific one. Any object controlled by the motor M can be employed as the control object.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A controller that controls a control object by driving a motor, the controller comprising:
an estimation unit that estimates a load of the control object on the basis of a value of a current applied to the motor; and
a switching unit that switches control contents between learning control in which learning is performed on the basis of the load estimation and normal control other than the learning control, wherein
the control contents in the learning control cause current fluctuation in the learning control to be further reduced than the current fluctuation in the normal control using other control contents.

2. The controller according to claim 1, wherein the switching unit switches the control contents from the control contents in the normal control to the control contents in the learning control only at certain timing.

3. The controller according to claim 2, wherein the switching unit stops the normal control at the certain timing.

4. The controller according to claim 1, wherein
the control object is controlled on the basis of feedback control performed on the motor, and
the switching unit switches at least one of a speed command value map corresponding to an actual rotation angle of the motor, a feedback gain, a filter, and a pulse width modulation frequency in the control contents.

5. The controller according to claim 2, wherein
the control object is controlled on the basis of feedback control performed on the motor, and
the switching unit switches at least one of a speed command value map corresponding to an actual rotation angle of the motor, a feedback gain, a filter, and a pulse width modulation frequency in the control contents.

6. The controller according to claim 3, wherein
the control object is controlled on the basis of feedback control performed on the motor, and
the switching unit switches at least one of a speed command value map corresponding to an actual rotation angle of the motor, a feedback gain, a filter, and a pulse width modulation frequency in the control contents.

7. The controller according to claim 2, wherein
the control object and the motor are mounted on a vehicle, and
the switching unit performs the switching at timing when an ignition switch of the vehicle is turned off and the timing is the certain timing.

8. The controller according to claim 3, wherein
the control object and the motor are mounted on a vehicle, and
the switching unit performs the switching at timing when an ignition switch of the vehicle is turned off and the timing is the certain timing.

9. A control method using a controller that controls a control object by driving a motor, the control method comprising:
estimating a load of the control object on the basis of a value of a current applied to the motor; and
switching control contents between learning control in which learning is performed on the basis of the load estimation and normal control other than the learning control, wherein
the control contents in the learning control cause current fluctuation in the learning control to be further reduced than the current fluctuation in the normal control using other control contents.

10. A clutch controller that controls a clutch of a vehicle by driving a motor, the clutch controller comprising:
an estimation unit that estimates a load of clutch control on the basis of a value of a current applied to the motor; and
a switching unit that switches control contents in clutch engagement operation or clutch disengagement operation between learning control in which learning is performed on the basis of the load estimation and normal control other than the learning control, wherein
the control contents in the learning control cause current fluctuation in the learning control to be further reduced than the current fluctuation in the normal control using other control contents.
